(19) United States
(12) Patent Application Publication
(10) Pub. No.: US 2026/0166643 A1
(43) Pub. Date: Jun. 18, 2026

(54) GAS DIFFUSER FOR LAMINAR GAS FLOW

(71) Applicant: Caterpillar Inc., Peoria, IL (US)

(72) Inventor: Dale Clifford Grigorenko, Moorhead, MN (US)

(73) Assignee: Caterpillar Inc., Peoria, IL (US)

(21) Appl. No.: 18/979,948

(22) Filed: Dec. 13, 2024

(51) Int. Cl. B23K 9/16

(52) U.S. Cl. CPC B23K 9/164

(57) ABSTRACT

A gas diffuser that has a generally flared profile from its gas inlet to its gas outlet is disclosed. The gas diffuser may be used in laser cladding processes to provide inert shield gas that results in reduced oxidation during laser cladding. The inlets of the gas conduits of the diffuser may be circular orifices and the outlets may be elongated, similar to an oval shape, orifices. The flared profile of the path of the inert gas within the gas diffuser results in a more collimated and laminar flow of the inert gas, with reduced levels of turbulence. The more laminar flow of the shield gas results in a greater exclusion of atmospheric oxygen from the melt pool during the laser cladding process, which results in reduced oxidation of the deposited cladding. The cladding formed using the gas diffuser may have reduced porosity and brittleness and greater uniformity.

### TECHNICAL FIELD

The present disclosure relates to a gas diffuser that allows for laminar gas flows. More specifically, the present disclosure relates to providing laminar gas flows for shield gas in cladding, hardfacing, and/or welding applications.

### BACKGROUND

Cladding, welding, and/or hardfacing applications rely on using molten metal to join two metal pieces or to coat a metal surface. Metals in their molten state are sensitive to oxidation and weld joints and/or cladding or hardfaced surfaces may have defects therein if oxidizing elements, such as atmospheric oxygen, is present during the cladding, hardfacing, and/or welding process. For example, oxidation during laser cladding a surface may result in a variety of defects, such as widespread porosity. To mitigate the effects of oxidation during cladding, hardfacing, and/or welding applications, a shield gas may be used to provide a non-oxidizing and/or non-reactive environment immediately in the region where the cladding, hardfacing, and/or welding is taking place. The shield gas, such as argon (Ar), acts as a shroud to exclude air, which includes oxygen and/or reactive gasses, from the immediate proximity of the molten weld pool in cladding, hardfacing, and/or welding applications.

Laser cladding may be particularly sensitive to the presence of atmospheric oxygen in air, as the process typically uses materials, such as 420 stainless steel (420SS), which may be more sensitive to oxidation than materials typically used for gas metal arc welding (GMAW). Furthermore, materials used for laser cladding typically do not include fluxing and/or deoxidizing agents, as GMAW materials typically include, that can chemically reduce, at least in part, any oxidation. Further still, laser clad surfaces often need to be of higher quality than weld joints that are formed by GMAW or other welding technologies. As a result, even small amounts of oxidizing and/or reactive agents in proximity of the melt pool during laser cladding can cause unacceptable levels of defects, such as porosity or brittle cladding. To mitigate the effects of the additional sensitivity to oxidation in laser cladding applications, it is important to have an effective flow of shield gas that acts as an effective shroud to exclude oxygen and/or reactants from the laser cladding melt pool.

One mechanism for providing shield gas is described in U.S. patent application No. 20230398606 (hereinafter referred to as “the '606 reference”). The '606 reference describes providing shield gas through two different paths, a low pressure shield gas flow and a high pressure shield gas flow. By having two different flows of shield gas, the '606 reference describes attempts to provide a more reliable shield gas shroud. However, the systems and methods described in the '606 reference require a more complex flow of shield gas and may require greater flows of shield gas. Furthermore, the approach of the '606 reference may not be compatible with preexisting tooling, such as laser cladding tools that are already in use.

Examples of the present disclosure are directed toward overcoming one or more of the deficiencies noted above.

### SUMMARY

In an aspect of the present disclosure, gas diffuser includes an outer sidewall extending from an inlet surface to an outlet surface opposing the inlet surface and an inner sidewall opposing the outer sidewall and extending from the inlet surface to the outlet surface, the inner sidewall and the outer sidewall is of an annular shape defining a longitudinal axis of the gas diffuser. The gas diffuser further includes one or more walls extending from the inlet surface to the outlet surface and between the inner sidewall and the outer sidewall, the one or more walls defining a gas conduit extending from the inlet surface to the outlet surface and a first edge within the inlet surface defining an inlet orifice of the gas conduit. The gas diffuser still further includes a second edge within the outlet surface defining an outlet orifice of the gas conduit, wherein a first area of the outlet orifice is greater than a second area of the inlet orifice.

In another aspect of the present disclosure, a method includes receiving, by a gas diffuser at an inlet orifice, shield gas and conducting, by the gas diffuser though a gas conduit defined by one or more walls of the gas diffuser, the shield gas to an outlet orifice and onto a melt pool. The inlet orifice is characterized by a first area, the outlet orifice is characterized by a second area, and the second area is greater than the first area.

In yet another aspect of the present disclosure, a laser cladding system, includes a tip configured to extend a wire to a surface and a laser configured to focus a laser beam onto the wire to generate a melt pool on the surface. The laser cladding system further includes a gas diffuser configured to conduct shield gas onto the melt pool, wherein the gas diffuser includes one or more walls extending from an inlet surface to an outlet surface, the one or more walls defining a gas conduit extending from the inlet surface to the outlet surface, wherein the gas conduit includes a flared profile from the inlet surface to the outlet surface.

### BRIEF DESCRIPTION OF DRAWINGS

FIG. 1 is a schematic illustration of an environment with an example laser cladding system, in accordance with examples of the disclosure.

FIG. 2 is a schematic illustration of an environment displaying an operation of the laser cladding system of FIG. 1, according to examples of the disclosure.

FIG. 3 is a schematic illustration of the laser cladding system with its housing removed, according to examples of the disclosure.

FIG. 4 is a schematic illustration of a perspective view of an inlet side of an example gas diffuser of the laser cladding system of FIG. 1, according to examples of the disclosure.

FIG. 5 is a schematic illustration of a perspective view of an outlet side of the example gas diffuser of FIG. 4, according to examples of the disclosure.

FIG. 6 is a schematic illustration of a sectional view of the outlet side of the example gas diffuser of FIG. 4, according to examples of the disclosure.

FIG. 7 is a schematic illustration of a semitransparent view of the inlet side of the example gas diffuser of FIG. 4, according to examples of the disclosure.

FIG. 8 is a flow diagram of an example method to clad, weld, and/or hardface with shield gas provided using the gas diffuser of FIG. 4, according to examples of the disclosure.

FIG. 9 is a schematic illustration of a shield gas flow envelope of a conventional gas diffuser and the gas diffuser of FIG. 4, according to examples of the disclosure.

### DETAILED DESCRIPTION

Wherever possible, the same reference numbers will be used throughout the drawings to refer to the same or like parts.

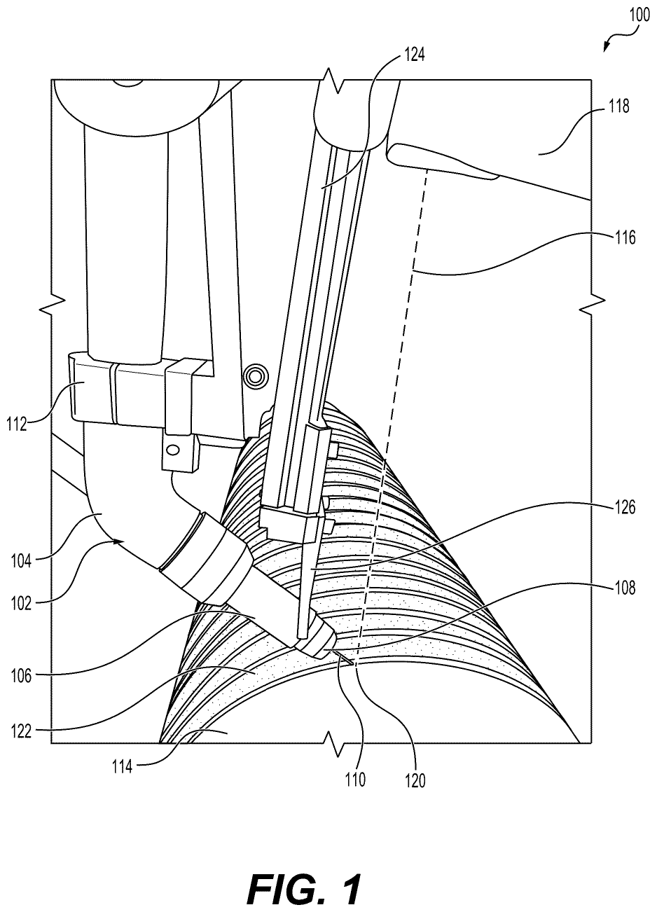

FIG. 1 is a schematic illustration of an environment 100 with an example laser cladding system 102, in accordance with examples of the disclosure. The laser cladding system 102, as disclosed herein, may include a housing 104, a tip cover 106. The tip cover 106 may have an orifice therein, defined by orifice edges 108. The laser cladding system 102 may be configured to extend a wire 110 through the orifice defined by edges 108. The laser cladding system 102 may further include a mount 112 to which the housing 104 of the laser cladding system 102 may be mechanically coupled. The mount 112 may be configured to move the extended wire 110 to a position that is in contact or close to being in contact with a surface 114 that is to be clad.

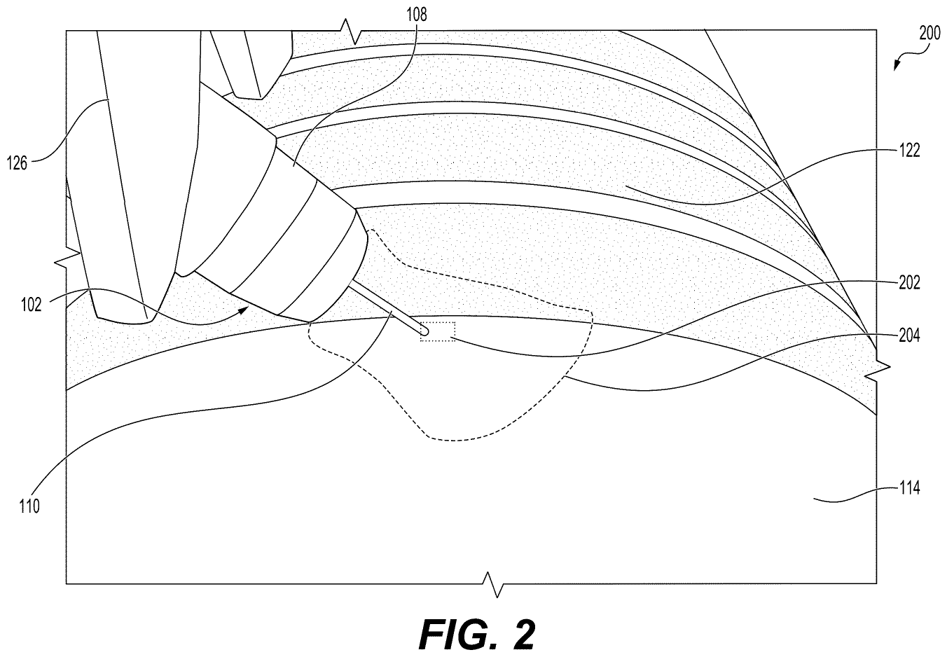

A light amplification by stimulated emission of radiation (laser) beam 116, as generated by a laser system 118, may be focused onto a focus point 120 on the wire 110 and/or on the surface 114. The laser beam 116 may cause the wire 110, as extended by the laser cladding system 102 through the orifice defined by edges 108, to melt into a melt pool, as described further in conjunction with FIG. 2. As the wire is melted onto the surface 114, more wire may be spooled out and extended by the laser cladding system 102 through the orifice. In this way, the wire 110 is consumed as it is melted onto the surface 114. As the material of the wire 110 cools and solidifies on the surface 114, cladding 122 is formed on the surface 114. As the wire 110 is consumed, new wire 110 is continuously spooled out to clad other portions of surface 114.

The laser system 218, generating the laser beam 116, may be of any suitable type, wavelength, duty cycle, and/or power. For example, the laser system 118 may be a carbon dioxide (CO₂) laser system, lasing at a wavelength between about 9 micrometers (μm) and about 11 μm. Other laser system 118 types may include neodymium-doped yttrium aluminum garnet (Nd:YAG) lasers, diode lasers, fiber lasers, or the like. In general, any type of laser may be used, as long as it produces sufficient thermal energy to melt the material of the wire 110. The material of the wire 110 may be any suitable material, such as 420SS, other steel materials, other iron materials, or the like. It should further be understood that the material for cladding may be introduced other than by the wire 110, such as by powder, ribbons, or the like.

The laser cladding system 102 may move the mount 112, and by extension the wire 110, and/or the surface 114, such that the wire 110 is proximal to a new location other than focus point 120, as focus point 120 is finished being clad. In other words, the laser cladding system 102 may be configured to move in any suitable scan pattern, such as in a rastered and/or continuous line motion, such that as a portion of the surface 114 is clad, a virgin portion of the surface 114 is clad next in a continuous and/or segmented process. In this way, the entirety and/or a desired portion of the surface 114 may be covered with cladding 122.

The laser cladding system 102 may further include an additional mount 124 and a shield 126 to prevent back splatter of molten metal onto the housing 104, the tip cover 106, and/or any other suitable parts of the laser cladding system 102. During high temperature processes with molten metal, portions of the metal may be splattered onto various parts of the laser cladding system 102. The shield 126 may result in some of the splatter not redepositing on parts of the laser cladding system 102, which may extend the operating times of various parts of the laser cladding system 102. In some cases, the shield 126 may be on its own mount 124 that moves along with the mount 112. In other cases, the shield 126 may be attached directly to the housing 104 or other parts of the laser cladding system 102.

FIG. 2 is a schematic illustration of an environment 200 displaying an operation of the laser cladding system 102 of FIG. 1, according to examples of the disclosure. The laser cladding system 102, when in operation, may generate a melt pool 202, which is a pool of molten metal on the surface 114. The melt pool 202 may include material from the wire 110 and/or the surface 114. In many cases, the melt pool 202 may include some material from both the wire 110 and the surface 114. The melt pool 202, as a temporary pool of molten metal, may be susceptible to rapid oxidation. Exposure to oxidizing agents, such as atmospheric oxygen, ozone, or the like can degrade the quality of the cladding 122 provided on the surface 114. For example, oxidation during the laser cladding process may result in undesirable porosity in the cladding 122 with holes having dimensions on the order of tens or hundreds of micrometers. Other defects from oxidation during the cladding process may include brittleness in the cladding 122. To the extent that cladding is often used to reduce corrosion and/or wear of parts, such as parts of machine struts, shocks, hydraulic elements, axles, and the like, porosity in the cladding can be detrimental to achieving the desired protection of the parts.

To prevent and/or reduce oxidation during the laser cladding process, the laser cladding system 102 may provide a shield gas 204, such as argon (Ar) or helium (He) or any suitable non-reactive gas. The shield gas 204 may be depicted as an envelope surrounding the melt pool 202. The shield gas 204 may prevent, or at least reduce, the exposure of atmospheric oxygen to the melt pool 202. To the extent that the shield gas 204 acts as a shroud and/or blocks atmospheric air from the regions around the melt pool 202, it is desirable for the shield gas 204 to be provided in a manner that is most effective in excluding atmospheric air form the melt pool 202. According to examples of the disclosure, apparatus, methods, and systems are disclosed herein that provide a more laminar flow of the shield gas 204 to provide a more effective shield gas compared to conventional systems and techniques.

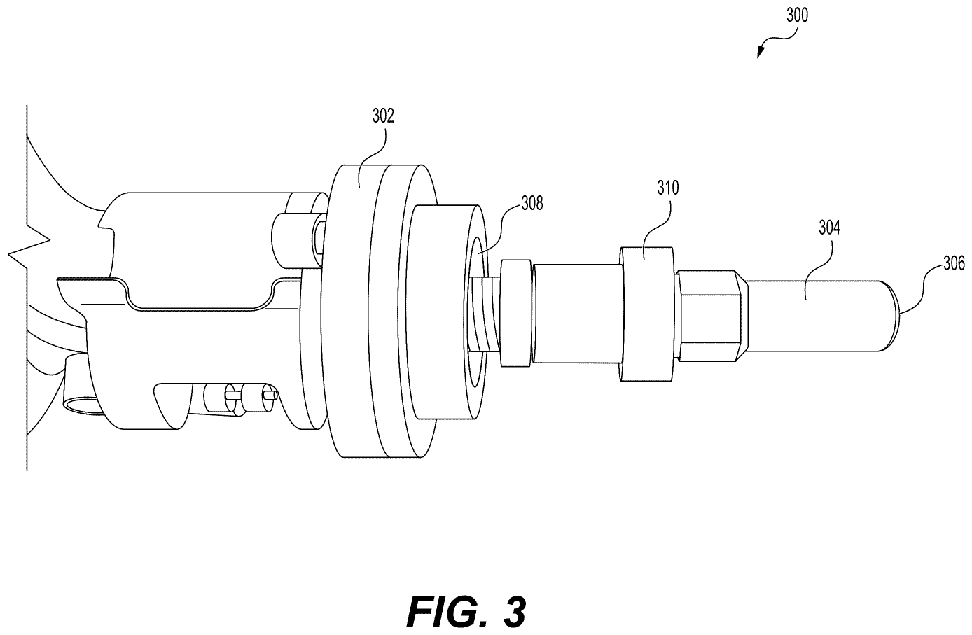

FIG. 3 is a schematic illustration of an environment 300 including the laser cladding system 102 with its tip cover 106 removed, according to examples of the disclosure. The laser cladding system 102 includes a base portion 302 configured to contact the tip cover 106 when the tip cover 106 is disposed on the laser cladding system 102. In other words, the base may allow the tip cover 106 to be securely held on the laser cladding system 102. The laser cladding system 102 may further include a tip 304, within which the wire 110 is extended, where the tip 304 extends to a tip end 306. The tip end 306 includes the edges 108 that define the orifice through which the wire 110 is extended. The laser cladding system 102 is configured to extend the wire 110 through the tip 304 and past the tip end 306 via the orifice therein, as defined by edges 108.

The laser cladding system 102 may further include a shield gas pathway 308 that conducts the shield gas 204 into a space defined between the tip 304 and the tip cover 106. The shield gas pathway 308 may be fluidically coupled to an upstream source (not shown) of the shield gas 204, such as a such as a pressurized gas cylinder. During operation, the wire 110 may be continuously extended from the tip end 306 and the shield gas 204 may flow from the shield gas pathway 308, as cladding 122 is deposited onto the surface 114. In this way, a continuous supply of wire 110 and shield gas 204 is provided by the laser cladding system 102 during the laser cladding process. The volume and/or velocity of shield gas 204, as supplied by the shield gas pathway 308, may be controlled by any suitable mechanism and/or apparatus, such as a regulator and/or a mass flow controller (MFC) associated with the supply of the shield gas 204, such as a pressurized gas cylinder.

The laser cladding system 102, according to examples of the disclosure, may include gas diffuser 310. The gas diffuser 310 may receive the shield gas 204 from the shield gas pathway 308 via a fluidic pathway defined by the tip 304 and the tip cover 106. The gas diffuser 310 receives the shield gas 204 and conducts the shield gas 204 in a manner that collimates the shield gas 204 to a more laminar flow of the shield gas 204. The laminar flow of the shield gas 204 improves the envelope of the shield gas 204 in protecting the melt pool 202 from oxidation. According to examples of the disclosure, the gas diffuser 310 is characterized by a geometry that provides a more collimated and laminar flow, with reduced levels of turbulence, of the shield gas 204 compared to conventional gas diffusers.

The gas diffuser 310, as disclosed herein, may include a geometry, such as a geometry of gas conduits extending within the gas diffuser 310, that improves the laminar flow and/or reduces turbulence in the flow, of the shield gas 204, as compared to conventional gas diffusers with conventional geometries. Furthermore, the gas diffuser 310 may be configured to replace conventional gas diffusers without changing the geometry of any of the other components of the laser cladding system 102. In other words, the gas diffuser 310, as disclosed herein, may be backwards compatible and may fit into preexisting laser cladding and/or other cladding, hardfacing, and/or welding systems.

The gas diffuser 310, as disclosed herein, may include one or more gas conduits that have a generally flared geometry. Put another way, the cross-sectional area along a longitudinal axis generally increases from upstream regions to downstream regions within the gas conduit. In some cases, the geometry is such that the gas inlet of the gas diffuser 310 may have a substantially circular geometry and the gas outlet of the gas diffuser 310 may have an oval-like and/or a rounded rectangle shape. The flared geometry results in volumetric expansion of the shield gas as it flows through the gas conduits of the gas diffuser 310. The volumetric expansion of the shield gas 204 may reduce the flow velocity of the shield gas 204 as it flows through the gas diffuser 310. This flared geometry of the gas conduits within the gas diffuser 310 also result in a more laminar and less turbulent flow of the shield gas 204 as compared to conventional gas diffusers that do not have a flared geometry.

While discussed in the context of the laser cladding system 102, the gas diffuser 310 may be used in variations of the laser cladding system 102 and/or other types of cladding, hardfacing, and/or welding systems to achieve a more collimated shield gas profile. This improved shield gas profile, as achieved with the use of gas diffuser 310, may be used in any suitable GMAW or other cladding, welding and/or hardfacing system. It should also be noted that although the laser cladding system 102 is depicted as an automated and/or computer controlled system, the gas diffuser 310 may be used in any laser cladding or arc cladding systems that are handheld.

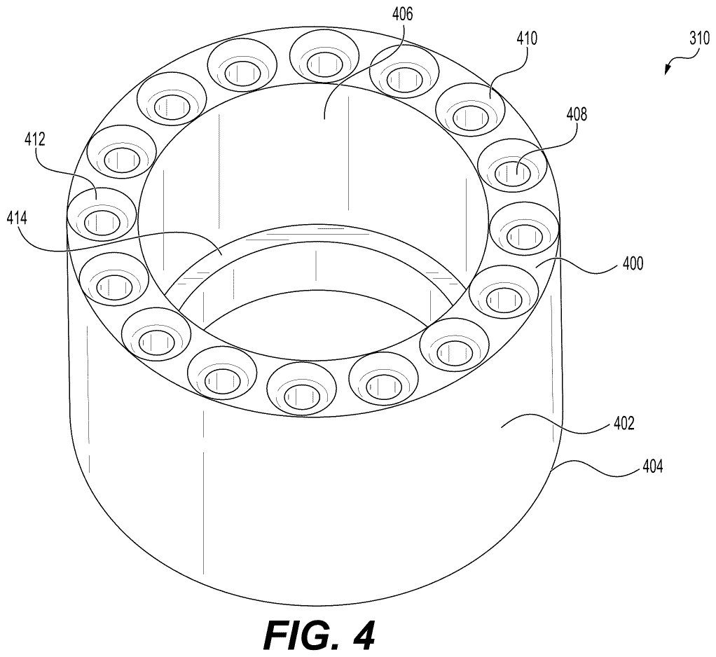

FIG. 4 is a schematic illustration of a perspective view of an inlet side of the gas diffuser 310 of the laser cladding system of FIG. 1, according to examples of the disclosure. The gas diffuser 310 may include an inlet surface 400 and an outer sidewall 402 that extends from the inlet surface 400 to an outlet surface 404 opposing the inlet surface 400. The gas diffuser 310 includes an inner sidewall 406 that opposes the outer sidewall 402 and also extends from the inlet surface 400 to the outlet surface 404. Orifice or inlet orifice 408 is defined by edges 410 in the inlet surface 400 between the inner sidewall 406 and the outer sidewall 402 of the gas diffuser 310. In other words, shield gas 204 from the shield gas pathway 308 may enter the inlet orifices 408 of the gas diffuser 310. In some cases, the inlet orifice 408 may define and inlet chamber 412 of the gas diffuser 310. The inlet chambers 412 may be an initial portion of shield gas conduits that extend from the inlet surface 400 to the outlet surface 404 of the gas diffuser 310. In some cases, the inner sidewall 406 of the gas diffuser 310 may include one or more ridges 414 that enable fitting the gas diffuser 310 onto the tip 304 of the laser cladding system 102.

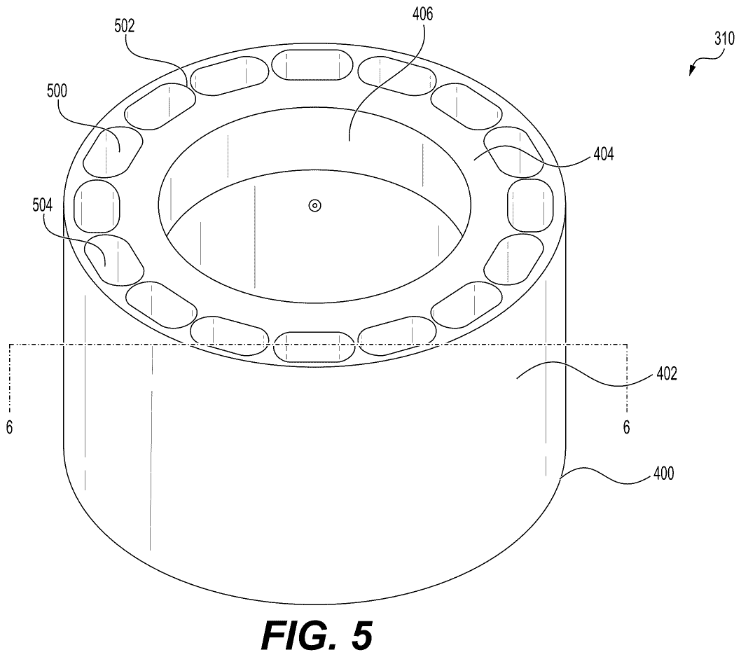

FIG. 5 is a schematic illustration of a perspective view of the outlet side of the example gas diffuser 310 of FIG. 4, according to examples of the disclosure. The outlet side may have one or more outlet orifices 500 in the outlet surface 404. Defined by edges 502. The edges 502 may further define an outlet chamber 504 of the gas diffuser 310. The outlet chambers 504 may be a final portion of shield gas conduits that extend from the inlet surface 400 to the outlet surface 404 of the gas diffuser 310. Shield gas 204 from the shield gas pathway 308, via the conduit between the tip 304 and the tip cover 106, enters the inlet orifices 408. The inlet orifice 408 conducts the shield gas 204 to the inlet chambers 412, which conducts the shield gas 204 to outlet chambers 504 and then out of the outlet orifice 500. The shield gas 204 then impinges upon the melt pool 202 and the surrounding region. This shield gas 204, as a result of the gas diffuser 310, as disclosed herein, is more laminar and less turbulent than shield gas conducted by conventional gas diffusers, such as gas diffusers that would not have a flared profile of the shield gas conduits.

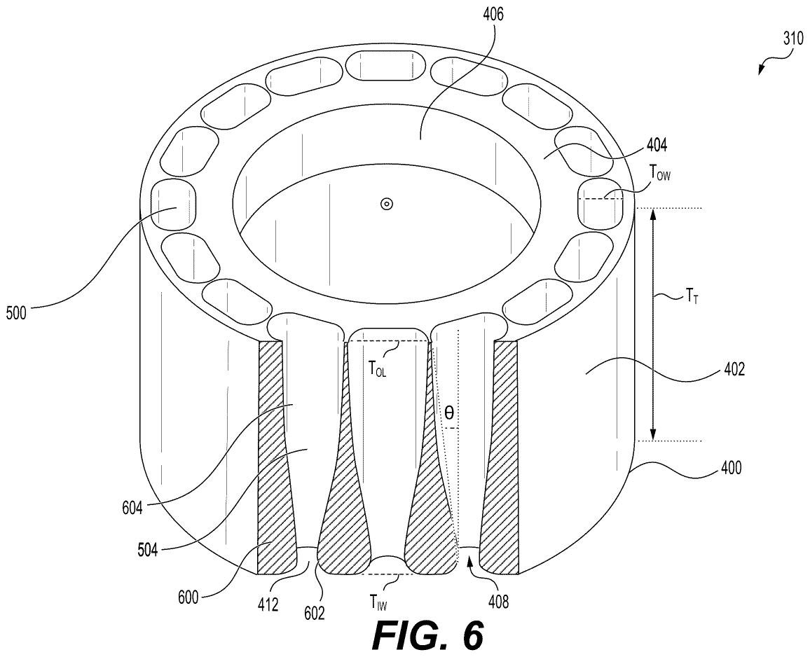

FIG. 6 is a schematic illustration of a sectional view of the outlet side of the example gas diffuser 310 of FIG. 5, according to examples of the disclosure. The inlet chamber 412 and the outlet chamber 504 are defined by sidewalls 600. The sidewalls 600 come to a pinch point 602. This pinch point 602 may be the narrowest point within the inlet chamber 412 and the outlet chamber 504. This pinch point 602 may define the interface between the inlet chamber 412 and the outlet chamber 504. The combination of the inlet chamber 412 and the outlet chamber 504 define a shield gas conduit 604. The shield gas conduit 604 has a generally flared profile. In other words, the outlet orifice 500 at the outlet surface 404 has a greater area than the inlet orifice 408 at the inlet surface 400.

The outlet orifice 500 may be an elongated, oval-like or rounded rectangle-like shape, while the inlet orifice 408 may be a circular shape. It should be understood, however, that the respective shapes as depicted are examples, and the disclosure herein contemplates other shapes of the inlet orifice 408 and/or the outlet orifice 500 that still provides a flared profile as shield gas 204 is conducted through the shield gas conduits 604. For example, variations of the geometry of the gas diffuser 310 may include smaller oval-shaped inlet orifices and larger oval-shaped outlet orifices. Other example variations of the geometry may include smaller circle-shaped inlet orifices and larger circle-shaped outlet orifices. Still other variations in the geometry may include smaller rectangle-shaped or rounded rectangle-shaped inlet orifices and larger rectangle-shaped or rounded rectangle shaped outlet orifices. In still other variations of the geometry may include other shapes of the inlet and/or outlet orifices and/or any combinations of the aforementioned shapes. Although, sixteen different shield gas conduits 604 are depicted through the gas diffuser 310, it should be understood that there may be any suitable number of the shield gas conduits. For example, in some cases, there may be fewer than sixteen shield gas conduits 604 and, in other cases, there may be greater than sixteen shield gas conduits 604.

The dimensions of the shield gas conduits 604, along with the inlet chamber 412 and the outlet chamber 504, may be any suitable size that provides an overall flared profile that has been demonstrated to provide a more laminar shield gas flow. Although example dimensions of the gas diffuser 310 are discussed herein, it should be understood that laser cladding systems, as well as similar other cladding, hardfacing, and/or welding systems, may have significant variations in size. As a result, the dimensions of the gas diffuser 310, as discussed herein, may vary according to the size of the laser cladding system 102 onto which it is installed. In some cases, the ratio of the various dimensions may also vary depending on the systems on which the gas diffuser 310 is installed. The dimensions of the gas diffuser 310, as discussed herein, may allow for the improved performance of gas diffuser 310, as compared to conventional gas diffusers. For example, the dimensions of the gas diffuser 310, such as the relative sizes of the inlet orifices 408 and the outlet orifices 500, may allow for the improved laminar flow of shield gas 204 impingent on the melt pool 202.

The outer diameter of the gas diffuser 310 may be any suitable size. In some cases, an outer diameter (e.g., the diameter of the outer sidewall 402) of the gas diffuser 310 may be in a range of about 12 millimeters (mm) to about 25 mm. In other cases, the outer diameter of the gas diffuser 310 may be in a range of about 14 mm to about 21 mm. In yet other cases, the outer diameter of the gas diffuser may be in a range of about 16 mm to about 19 mm. For example, in one case, the outer diameter of the gas diffuser 310 may be approximately 17.7 mm. The gas diffuser 310 may have any suitable thickness (T_{T}). In some cases, the T_{T} in a range of about 5 mm to about 25 mm. In other cases, the T_{T} may be in a range of about 8 mm and about 15 mm. In still other cases, the T_{T} may be in a range of about 10 mm and about 12 mm. For example, in one non-limiting case, the T_{T} may be about 11 mm.

The inlet width (T_{IW}) of the inlet orifice 408 may be any suitable size. Ion some cases, T_{IW} may be in a range of about 0.7 mm to about 2 mm. In other cases, the T_{IW} may be in a range of about 0.9 mm to about 1.6 mm. In yet other cases, the T_{IW} may be in a range of about 1 mm to about 1.4 mm. For example, in one non-limiting case, the T_{IW} may be approximately 1.25 mm. The outlet width (T_{OW}) of the outlet orifice 500 may be any suitable size. In some cases, the T_{OW} may be greater than T_{IW}. In some cases, T_{OW} may be in a range of about 1 mm to about 2.5 mm. In other cases, the T_{OW} may be in a range of about 1.2 mm to about 2 mm. In yet other cases, the T_{OW} may be in a range of about 1.5 mm to about 1.7 mm. For example, in one limiting case, the T_{OW} may be approximately 1.6 mm. The outlet length (T_{OL}) of the outlet orifice 500 may be of any suitable size. In some cases, T_{OL} may be in a range of about 1.3 mm to about 5 mm. In other cases, T_{OL} may be in a range of about 2 mm to about 4 mm. In yet other cases, T_{OL} may be in a range of about 2.5 mm to about 3.5 mm. For example, in one non-limiting case, T_{OL} may be approximately 3.05 mm.

A ratio of T_{IW}:T_{OW} may be any suitable value. In some cases, the ratio of T_{IW}:T_{OW} may be in a range of about 1:0.9 to about 1:2. In other cases, the ratio of T_{IW}:T_{OW} may be in a range of about 1:1 to about 1:1.6. In still other cases, the ratio of T_{IW}:T_{OW} may be in a range of about 1:1.1 to about 1:1.4. For example, in one non-limiting example, the ratio of T_{IW}:T_{OW} may be about 1:1.28. In other words, in the aforementioned example, the outlet width of the outlet orifice 500 may be about 28% greater than the inlet width of the inlet orifice 408. A ratio of T_{IW}:T_{OL} may be any suitable value. In some cases, the ratio of T_{IW}:T_{OL} may be in a range of about 1:1.5 to about 1:3.5. In other cases, the ratio of T_{IW}:T_{OL} may be in a range of about 1:1.9 to about 1:3. In still other cases, the ratio of T_{IW}:T_{OL} may be in a range of about 1:2.2 to about 1:2.7. For example, in one non-limiting example, the ratio of T_{IW}:T_{OL} may be about 1:2.43. In other words, in the aforementioned example, the outlet length of the outlet orifice 500 may be about 143% greater than the inlet width of the inlet orifice 408.

The sidewall angle (θ) of the shield gas conduits 604 may be of any suitable angle. In some cases, θ may be less than about 10°. In some cases, θ may be less than about 8°. In some cases, θ may be less than about 7°. In some cases, θ may be less than about 6°. In some cases, θ may be less than about 5°. In some cases, θ may be less than about 4°. For example, in one non-limiting case, θ may be approximately 4.66°. It should be understood that the aforementioned discussion of sidewall angles of the shield gas conduits 604 may be average angles from the inlet orifice 408 to the outlet orifice 500, as the sidewall angles are not consistent along the entire path of the shield gas conduits 604. In other words, while the inlet chamber 412 may have a tapered profile and the outlet chamber 504 may have a flared profile. However, the overall shield gas conduit 604 may have a generally flared profile, as the outlet orifice 500 has a greater area than the inlet orifice 408. In some cases, the area of the outlet orifice 500 to the area of the inlet orifice 408 may range from about 1.5 to about 5. In other cases, the area of the outlet orifice 500 to the area of the inlet orifice 408 may range from about 2 to about 4. In yet other cases, the area of the outlet orifice 500 to the area of the inlet orifice 408 may range from about 2.5 to about 3.5. For example, in one non-limiting case, the area of the outlet orifice 500 to the area of the inlet orifice 408 may be approximately 3.11 (e.g., the area of the outlet orifice 500 being 211% larger than the area of the inlet orifice 408).

It should be appreciated that the dimensions, angles, and dimensional ratios as discussed herein allow for the advantageous supply of shield gas 204 during the laser cladding process. For example, the sidewall angle (θ) of the shield gas conduits 604 being less than 7° may allow for the preferred laminar flow of shield gas 204 that reduces the likelihood of oxidation of the cladding 122. It should also be understood that the disclosure herein contemplates ranges of dimensions, angles, and/or dimensional ratios for larger or smaller laser cladding systems or similar cladding, hardfacing, and/or welding systems.

It should also be understood that the configuration of the shield gas conduits 604 with the inlet chamber 412 and the outlet chamber 504 transition at the pinch point 602 may contribute to the preferred laminar shield gas flow, as disclosed herein. The inlet chamber 412 with a symmetrical (e.g., circular) inlet orifice 408 may effectively collect, without excessive impedance, the shield gas 204 supplied from the shield gas pathway 308. The shield gas 204 may proceed toward the pinch point 602 which may concentrate the flow of the shield gas 204. In other words, the inlet chamber 412 may include a tapered profile. As the shield gas 204 passes into the outlet chamber 504, the shield gas may follow a flared profile that leads to a volumetric expansion of the shield gas as it flows toward the outlet orifice 500. In other words, the outlet chamber 504 may include a flared profile. This collection, compression, and decompression of the shield gas 204, as it moves through the gas diffuser 310, may contribute to the preferred laminar flow of the shield gas, as disclosed herein.

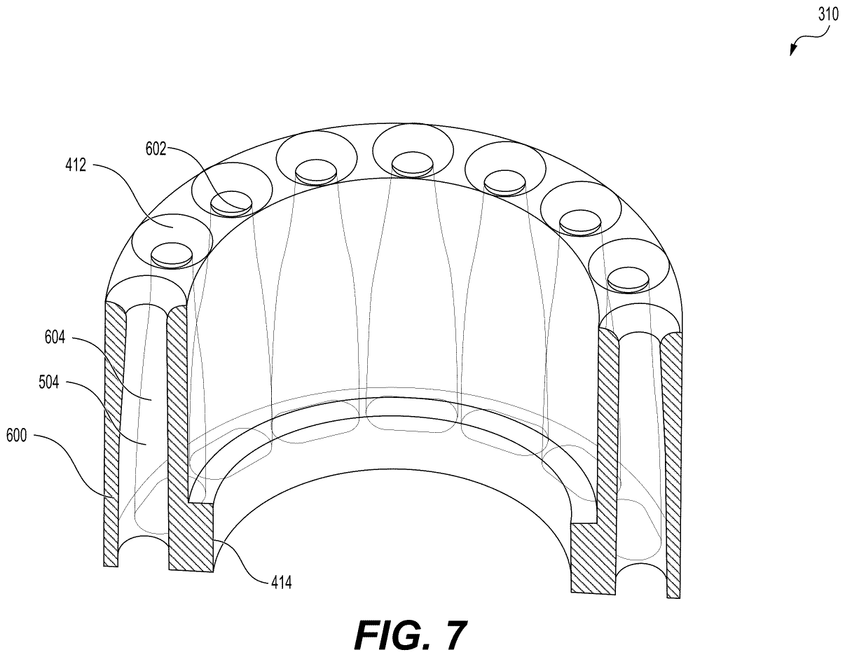

FIG. 7 is a schematic illustration of a semitransparent view of the inlet side of the example gas diffuser 310 of FIG. 4, according to examples of the disclosure. As shown, the shield gas conduits 604 of the gas diffuser 310 are flared, or in other words, shield gas 204 expands as it traverses through the gas diffuser 310. The expansion of the shield gas 204 as it traverses through the gas diffuser 310, due to the flared geometry of the shield gas conduits 604, causes the shield gas 204 to slow down. Additionally, the flared geometry of the shield gas conduits 604 provides for a less turbulent and more columnar profile of the shield gas 204 as it impinges on the cladding area, such as the melt pool 202.

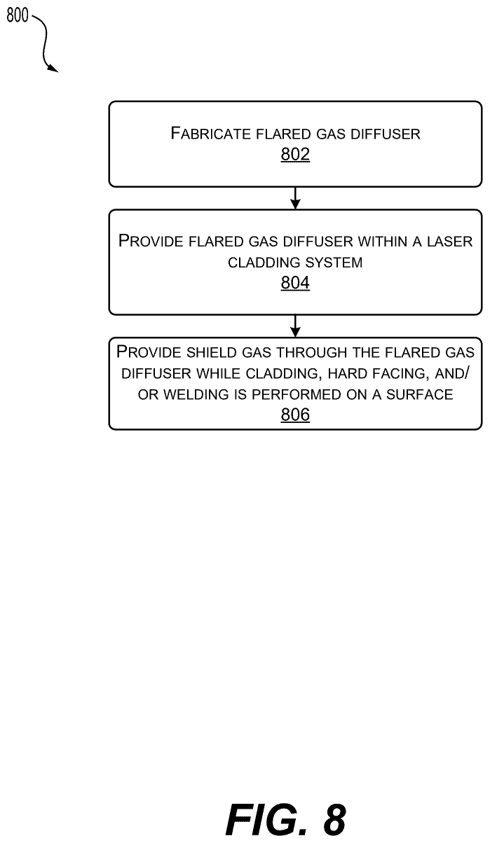

FIG. 8 is a flow diagram of an example method 800 to clad, weld, and/or hardface with shield gas 204 provided using the gas diffuser 310 of FIG. 4, according to examples of the disclosure. It should be understood that the operations of method 800 may be performed by an automated tool, such as the laser cladding system 102 of FIG. 1. Alternatively, the method 800 may be performed using systems similar to laser cladding system 102, such as handheld (e.g., human operated) laser cladding systems or other similar cladding, hardfacing, and/or welding systems (e.g., GMAW, TIG welding, MIG welding, etc.).

At block 802, a flared gas diffuser may be fabricated. The flared gas diffuser may include the gas diffuser 310 of FIG. 4. The gas diffuser 310 may be fabricated using any suitable technique and/or with any suitable materials. For example, the gas diffuser may be fabricated using any suitable polymer and/or plastic materials, such as nylon, using injection molding or 3D printing. Other polymeric materials of construction of the gas diffuser 310 may include polycarbonate, polypropylene, polyethylene, polybutylene terephthalate, or the like. The gas diffuser 310 alternatively be formed from any variety of metal, such as stainless steel, aluminum, or the like, using any suitable process, such as casting, forging, any variety of machining, or the like. In yet other alternatives, the gas diffuser 310 may be fabricated from ceramic materials, using any suitable technique, such as slip casting, molding, power sintering, or the like.

At block 804, the flared gas diffuser may be provided on a laser cladding system. The laser cladding system 102 may have the gas diffuser 310 disposed around the tip 304, as depicted in FIG. 3. The gas diffuser 310, as disclosed herein, may be dimensioned in a manner such that the gas diffuser has the same overall diameter and/or length as preexisting conventional gas diffusers. Accordingly, the gas diffuser 310 may be installed onto the laser cladding system 102, or similar cladding, hardfacing, and/or welding system, as a replacement for a conventional gas diffuser without modification of any other parts of the laser cladding system 102. In alternative cases, some modification of other parts of a cladding, hardfacing, and/or welding system may be needed to accommodate the gas diffuser 310, as disclosed herein.

At block 806, shield gas may be provided through the flared gas diffuser while cladding, hardfacing, and/or welding is performed on a surface. The hot-wire laser cladding system 102 may be machine controlled or human controlled and may proceed with extending the wire 110 through the tip end 306 and melting the wire 110 onto the surface 114 as cladding 122. As this process proceeds, the shield gas 204 may be blown through the gas diffuser 310 onto the regions proximal to where the cladding is being performed, including, but not limited to, the melt pool 202. The use of the gas diffuser 310 to provide the shield gas 204 onto the melt pool 202 provides a more laminar shield gas flow compared to conventional gas diffusers, resulting in reduced oxidation and a higher quality cladding 122. This higher quality cladding 122 may have fewer and/or smaller porosity and/or reduced brittleness compared to conventional cladding processes performed without the benefit of the flared gas diffuser 310, as disclosed herein.

The volumetric rate for flowing the shield gas 204 may be set such that there is sufficient exclusion of air, having atmospheric oxygen therein, from the melt pool 202 and surrounding regions. In some cases, the gas diffuser 310 may enable a greater overall shield gas flow compared to conventional gas diffusers due to the flared profile of the shield gas conduits 604 of the gas diffuser 310. In some cases, the shield gas flow at greater gas flow velocity may be less turbulent and more collimated than would be achievable using conventional gas diffusers without a flared profile. In some cases, the shield gas 204 may be provided onto the melt pool 202 and surrounding regions at greater than 10 cubic feet per hour (CFH). In other cases, the shield gas 204 may be provided at greater than 20 CFH. In still other cases, the shield gas 204 may be provided at less than 60 CFH. In yet other cases, the shield gas 204 may be provided at less than 50 CFH. In some cases, the shield gas 204 may be provided onto the melt pool 202 at a flow rate range of about 20 CFH to about 55 CFH. In other cases, the shield gas 204 may be provided onto the melt pool 202 at a flow rate range of about 30 CFH to about 50 CFH. The rate at which the shield gas 204 is provided through the gas diffuser 310 may affect the level of collimation and turbulence of the shield gas 204.

It should be noted that some of the operations of method 800 may be performed out of the order presented, with additional elements, and/or without some elements. Some of the operations of method 800 may further take place substantially concurrently and, therefore, may conclude in an order different from the order of operations shown above.

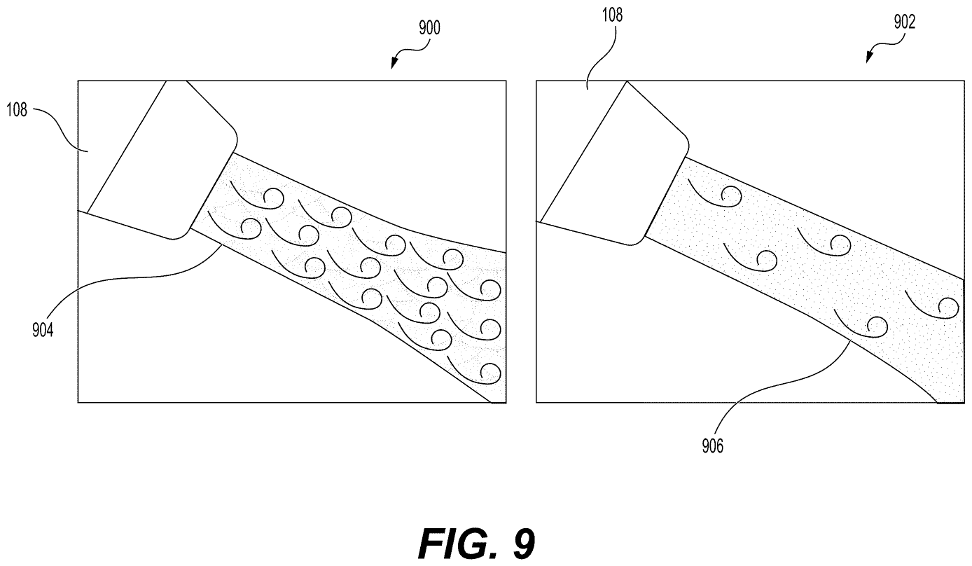

FIG. 9 is a schematic illustration of a shield gas flow image 900 of a conventional gas diffuser and a shield gas flow image 902 of the gas diffuser 310 of FIG. 4, according to examples of the disclosure. Image 900 shows a shield gas flow envelope 904 of conventional gas diffusers and image 902 shows a shield gas flow envelope 906 of the gas diffuser 310. Images 900, 902 may be generated by any suitable mechanism, such as Schlieren flow visualization. As shown, the shield gas flow envelope 906 of gas diffuser 310 is tighter and more laminar, with reduced turbulence, than the shield gas flow envelope 904 of conventional gas diffusers. It is this more laminar flow of shield gas 204 using the gas diffuser 310, with flared shield gas conduits therein, allows for a greater exclusion of atmospheric oxygen from the melt pool 202 in laser cladding, hardfacing, and/or welding applications. As a result, cladding, hardfacing, and/or welding with using the gas diffuser 310, as disclosed herein, results in reduced oxidation compared to using conventional gas diffusers.

### INDUSTRIAL APPLICABILITY

The present disclosure describes systems and methods for providing gas diffuser 310 with a flared profile for a laser cladding system 102 or other cladding, welding, and/or hardfacing system. Cladding processes, such as laser cladding, can be sensitive to oxidation when depositing the cladding, since molten metals are generally susceptible to oxidation, even when oxygen is present in minute quantities. As discussed herein, oxidation of cladding, welding, and/or hardfacing materials may result in a number of infirmities, such as cladding porosity and/or brittleness. To the extent that cladding is often used to reduce corrosion and/or wear of parts, such as parts of machine struts, shocks, hydraulic elements, axels, and the like, porosity in the cladding can be detrimental to achieving the desired protection of the parts. The gas diffuser 310, as disclosed herein, provides a more laminar and less turbulent shield gas flow reduce and/or eliminate oxidation during the laser cladding process.

The gas diffuser 310, by providing improved resistance to oxidation during a cladding process may result in improved corrosion resistance and improved wear resistance of components clad using the gas diffuser and cladding systems described herein. Thus, the gas diffuser 310, as disclosed herein, results in improved lifetimes of mechanical parts, such as parts that may be used in heavy machinery. For example, undercarriage components of a heavy earthmoving machine clad using the apparatus, systems, and/or processes disclosed herein may provide improved usable lifetimes. Longer lifetimes of these parts result in improved return on capital (ROC) and return on investment (ROI). Furthermore, improved lifetimes of such parts may also reduce the amount of human involvement required to maintaining, replacing and/or refurbishing components. Additionally, worksites, such as a mining site may benefit from greater production efficiency because the parts last longer and there is reduced average machine downtime for maintenance.

Although the systems herein are discussed in the context of a laser cladding system 102, it should be appreciated that the systems and methods discussed herein may be applied to a wide array of cladding, hardfacing, welding, combinations thereof, or the like. For example, the gas diffuser 310 with its improved gas delivery may be used in GMAW or similar cladding, hardfacing, and/or welding systems. The gas diffuser 310 may further be used for other applications that require a highly collimated and/or laminar fluid flow.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A gas diffuser, comprising:
an outer sidewall extending from an inlet surface to an outlet surface opposing the inlet surface;
an inner sidewall opposing the outer sidewall and extending from the inlet surface to the outlet surface, the inner sidewall and the outer sidewall is of an annular shape defining a longitudinal axis of the gas diffuser;
one or more walls extending from the inlet surface to the outlet surface and between the inner sidewall and the outer sidewall, the one or more walls defining a gas conduit extending from the inlet surface to the outlet surface;
a first edge within the inlet surface defining an inlet orifice of the gas conduit; and
a second edge within the outlet surface defining an outlet orifice of the gas conduit, wherein a first area of the outlet orifice is greater than a second area of the inlet orifice.

2. The gas diffuser of claim 1, wherein the one or more walls define a second gas conduit extending from the inlet surface to the outlet surface, wherein the second gas conduit includes a flared profile.

3. The gas diffuser of claim 1, wherein the inlet orifice includes a circular shape and the outlet orifice includes at least one of: an elongated shape, an oval-like shape, or a rounded rectangle shape.

4. The gas diffuser of claim 1, wherein the gas conduit includes a flared profile with the one or more walls having an angle relative to the longitudinal axis of the gas diffuser of less than 7 degrees.

5. The gas diffuser of claim 4, wherein the angle of the one or more walls relative to the longitudinal axis of the gas diffuser is less than 5 degrees.

6. The gas diffuser of claim 1, wherein the one or more walls define an inlet chamber and an outlet chamber, wherein the inlet chamber includes a tapered profile and the outlet chamber includes a flared profile.

7. The gas diffuser of claim 6, wherein the one or more walls include a pinch point, wherein the pinch point defines an interface between the inlet chamber and the outlet chamber.

8. The gas diffuser of claim 1, wherein a ratio of the first area to the second area is greater than 1.5.

9. The gas diffuser of claim 1, wherein a ratio of the first area to the second area is greater than 2 and less than 4.

10. A method, comprising:
receiving, by a gas diffuser at an inlet orifice, shield gas; and
conducting, by the gas diffuser through a gas conduit defined by one or more walls of the gas diffuser, the shield gas to an outlet orifice and onto a melt pool, wherein:
the inlet orifice is characterized by a first area,
the outlet orifice is characterized by a second area, and
the second area is greater than the first area.

11. The method of claim 10, further comprising:
extending, via a tip, a wire proximal to a surface;
focusing a laser beam onto the wire to form the melt pool while the shield gas is impingent on the melt pool; and
allowing the melt pool to cool to form cladding on the surface.

12. The method of claim 10, further comprising:
providing, via a shield gas pathway, the shield gas to the gas diffuser, wherein the shield gas is flowed at a rate greater than 20 cubic feet per hour (CFH).

13. The method of claim 10, wherein the shield gas is flowed at a rate less than 50 CFH.

14. The method of claim 10, wherein the gas conduit includes a flared profile with the one or more walls having an angle relative to a longitudinal axis of the gas diffuser of less than 7 degrees.

15. A laser cladding system, comprising:
a tip configured to extend a wire to a surface;
a laser configured to focus a laser beam onto the wire to generate a melt pool on the surface; and
a gas diffuser configured to conduct shield gas onto the melt pool, wherein the gas diffuser includes one or more walls extending from an inlet surface to an outlet surface, the one or more walls defining a gas conduit extending from the inlet surface to the outlet surface, wherein the gas conduit includes a flared profile from the inlet surface to the outlet surface.

16. The laser cladding system of claim 15, further comprising:
a shield gas pathway configured to provide shield gas to the gas diffuser.

17. The laser cladding system of claim 15, further comprising:
a first edge within the inlet surface defining an inlet orifice of the gas conduit; and
a second edge within the outlet surface defining an outlet orifice of the gas conduit, wherein a first area of the outlet orifice is greater than a second area of the inlet orifice.

18. The laser cladding system of claim 17, wherein the first area is at least twice the second area.

19. The laser cladding system of claim 15, wherein the gas conduit includes an inlet chamber that is tapered and an outlet chamber that is flared in a direction of a shield gas flow through the gas diffuser.

20. The laser cladding system of claim 19, wherein the one or more walls include a pinch point, wherein the pinch point defines an interface between the inlet chamber and the outlet chamber.
